(19) United States
(12) Patent Application Publication
(10) Pub. No.: US 2024/0293974 A1
(43) Pub. Date: Sep. 5, 2024

(54) 3D PRINTING WITH REINFORCEMENT OPTIMIZATION

(71) Applicant: Markforged, Inc., Waltham, MA (US)

(72) Inventors: Bruce David Jones, Sudbury, MA (US); Brady Adams, Sudbury, MA (US); Jeffrey Lee Selden, Ellensburg, WA (US)

(21) Appl. No.: 18/590,027

(22) Filed: Feb. 28, 2024

Related U.S. Application Data
(60) Provisional application No. 63/487,946, filed on Mar. 2, 2023.

(51) Int. Cl. B29C 64/393; B29C 64/336; B33Y 10/00; B33Y 50/02

(52) U.S. Cl. CPC B29C 64/393; B29C 64/336; B33Y 10/00; B33Y 50/02

(57) ABSTRACT

A 3D printing apparatus and method determines an optimized reinforcement strategy for improving one or more mechanical properties of a part to be printed. The optimization may include determining reinforcement parameters which yield the highest improvement in such mechanical properties. The reinforcement parameters may include one or more particular portions of the part to print using a reinforced material, a fiber orientation, a density of print material.

### FIELD OF THE INVENTION

The invention relates to an apparatus and method for 3D printing with optimizing the reinforcement of a 3D part to be printed.

### BACKGROUND OF THE INVENTION

Typically, fused-filament fabrication (FFF) 3D printing involves printing filament in the X-Y plane, in a layer-by-layer fashion that creates successive layers to form the part. Optionally, continuous fibers can also be printed to reinforce the parts greatly increasing mechanical properties in the X-Y plane. Apparatuses and methods for printing continuous fiber are described, for example, in U.S. Pat. Nos. 10,076,876, 9,579,851, 9,694,544, 9,370,896, 11,237,542, 9,186,846, 9,186,848, and 9,688,028, each of which is incorporated by reference herein in its entirety.

In a circumstance where a part design requires additional reinforcement in order to satisfy one or more imposed mechanical requirements (e.g., as defined by a specification), the best approach to determine where to apply reinforcement may not be apparent. For instance, it may not be cost-effective to reinforce the entire part, as reinforced material may be more expensive than unreinforced material. Furthermore, reinforcement of certain areas of the part may not necessarily even improve the mechanical requirement(s). In some circumstances, even reinforcement of an entire print layer may not be necessary and may not yield improvement in the mechanical requirement(s) over reinforcing just a portion of that print layer.

Therefore, a need exists in determining an optimized application of reinforcement so as to address the necessary mechanical requirement(s) while minimizing the excess or unnecessary application of reinforcement.

### SUMMARY OF THE INVENTION

One aspect of the present invention relates to an apparatus comprising at least one processor; and at least one memory, wherein the at least one memory stores computer-readable instructions which, when executed by the at least one processor, cause the processor to: receive design data corresponding to an object; determine, based on the design data, at least one physical property of the object in the case that the object is 3D-printed using a first print material; determine, based on the design data, one or more portions of the object to be printed using a second print material different from the first print material, the second print material having an increased reinforcement amount compared to the first print material; and generate production data based on the design data and the one or more portions determined to be printed using the second print material.

Another aspect of the present invention relates to a method comprising receiving design data corresponding to an object; determining, based on the design data, at least one physical property of the object in the case that the object is 3D-printed using a first print material; determining, based on the design data, one or more portions of the object to be printed using a second print material different from the first print material, the second print material having an increased reinforcement amount compared to the first print material; and generating production data based on the design data and the one or more portions determined to be printed using the second print material.

Yet another aspect of the present invention relates to a non-transitory computer-readable medium storing a computer program which, when executed by at least one processor, causes the processor to: receive design data corresponding to an object; determine, based on the design data, at least one physical property of the object in the case that the object is 3D-printed using a first print material; determine, based on the design data, one or more portions of the object to be printed using a second print material different from the first print material, the second print material having an increased reinforcement amount compared to the first print material; and generate production data based on the design data and the one or more portions determined to be printed using the second print material.

These and other aspects of the invention will become apparent from the following disclosure.

### BRIEF DESCRIPTION OF THE DRAWINGS

FIGS. 1A and 1B illustrate an apparatus, in accordance with one embodiment.

FIG. 2 is a flow chart for an operation for determining an optimized reinforcement strategy for a part to be printed and creating a printing procedure for the part based on the reinforcement strategy, in accordance with one embodiment.

FIG. 3 is a flow chart for an operation for determining an optimized reinforcement strategy for a part to be printed and creating a printing procedure for the part based on the reinforcement strategy, in accordance with one embodiment.

FIG. 4 is a flow chart for an operation for determining an optimized reinforcement strategy for a part to be printed and creating a printing procedure for the part based on the reinforcement strategy, in accordance with one embodiment.

FIG. 5 is a flow chart for an operation for determining an optimized reinforcement strategy for a part to be printed and creating a printing procedure for the part based on the reinforcement strategy, in accordance with one embodiment.

FIG. 6 is a flow chart for an operation for determining an optimized reinforcement strategy for a part to be printed and creating a printing procedure for the part based on the reinforcement strategy, in accordance with one embodiment.

FIG. 7 illustrates an example part to be printed.

FIG. 8 illustrates a reinforcement strategy for the example part of FIG. 7, in accordance with one embodiment.

FIG. 9 illustrates a reinforcement strategy for the example part of FIG. 7, in accordance with one embodiment.

FIG. 10 illustrates partitioning of print layers for a reinforcement strategy for the example part of FIG. 7, in accordance with one embodiment.

### DETAILED DESCRIPTION OF THE PREFERRED EMBODIMENTS

The present invention relates to an apparatus and method of determining an optimized reinforcement strategy for improving one or more mechanical properties (e.g., physical properties) of a part to be printed. The present invention performs such optimization by determining reinforcement parameters which yield the highest improvement in such mechanical properties, providing the best “bang for the buck” in applying the reinforcement.

### 3D Printer Apparatus

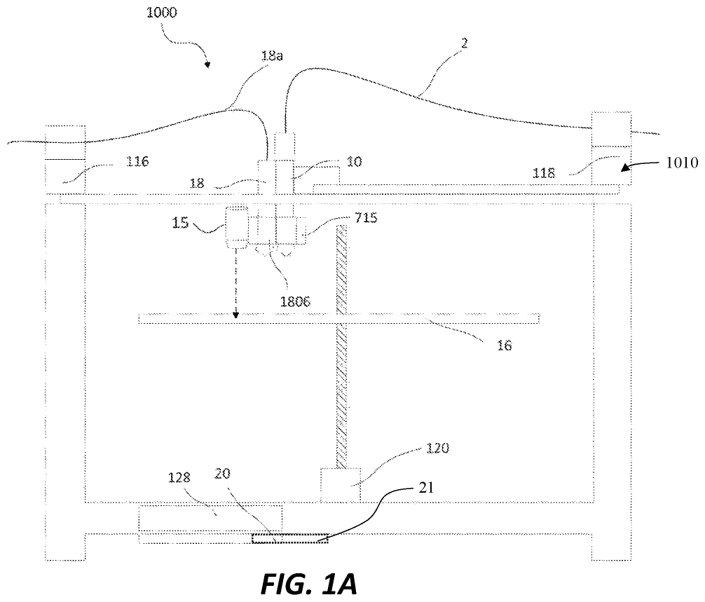

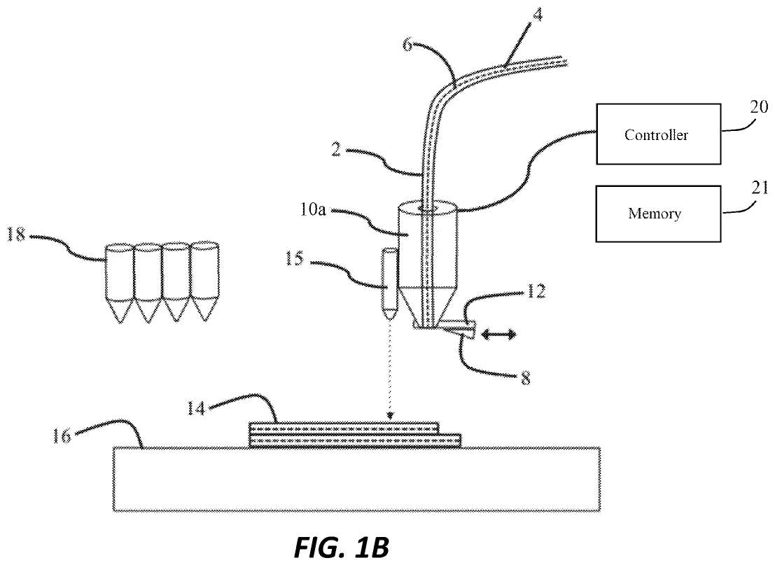

FIGS. 1A-1B illustrate an apparatus 1000 in accordance with one embodiment of the invention. The apparatus 1000 includes one or more controllers 20, one or more memories 21, and one or more print heads 10, 18. For instance, one head 10 may deposit a metal or fiber reinforced composite filament 2, and another head 18 may apply pure or neat matrix resin 18a (thermoplastic or curing), which may include, but is not limited to, a polymer or curable monomer and/or a polymer or curable monomer filled, e.g., with chopped carbon fiber, carbon black, silica, and/or aramid fiber. In the case of the filament 2 being a fiber reinforced composite filament, such filament (also referred to herein as continuous core reinforced filament) may be substantially void free and include a polymer or resin that coats, permeates or impregnates an internal continuous core (including, but not limited to, single, multi-strand, or multi-material). It should be noted that although the print head 18 is shown as an extrusion print head, “fill material print head” 18 as used herein includes optical or UV curing, heat fusion or sintering, or “polyjet”, liquid, colloid, suspension or powder jetting devices (not shown) for depositing fill material. It will also be appreciated that a material bead formed by the filament 2 may be deposited as extruded thermoplastic or metal, deposited as continuous or semi-continuous fiber, solidified as photo or UV cured resin, or jetted as metal or binders mixed with plastics or metal, or are structural, functional or coatings. The fiber reinforced composite filament 2 (also referred to herein as continuous core reinforced filament) may be a push-pulpreg that is substantially void free and includes a polymer or resin 4 that coats or impregnates an internal continuous single core or multistrand core 6. The apparatus includes heaters 715, 1806 to heat the print heads 10, 18, respectively so as to facilitate deposition of layers of material to form the object 14 to be printed. A cutter 8 controlled by the controller 20 may cut the filament 2 during the deposition process in order to (i) form separate features and components on the structure as well as (ii) control the directionality or anisotropy of the deposited material and/or bonded ranks in multiple sections and layers. As depicted, the cutter 8 is a cutting blade associated with a backing plate 12 located at the nozzle outlet. Other cutters include laser, high-pressure air or fluid, or shears. The apparatus 1000 may also include additional non-printing tool heads, such as for milling, SLS, etc.

The apparatus 1000 includes a gantry 1010 that supports the print heads 10, 18. The gantry 1010 includes motors 116, 118 to move the print heads 10, 18 along X and Y rails in the X and Y directions, respectively. The apparatus 1000 also includes a build platen 16 (e.g., print bed) on which an object to be printed is formed. The height of the build platen 16 is controlled by a motor 120 for Z direction adjustment. Although the movement of the apparatus has been described based on a Cartesian arrangement for relatively moving the print heads in three orthogonal translation directions, other arrangements are considered within the scope of, and expressly described by, a drive system or drive or motorized drive that may relatively move a print head and a build plate supporting a 3D printed object in at least three degrees of freedom (i.e., in four or more degrees of freedom as well). For example, for three degrees of freedom, a delta, parallel robot structure may use three parallelogram arms connected to universal joints at the base, optionally to maintain an orientation of the print head (e.g., three motorized degrees of freedom among the print head and build plate) or to change the orientation of the print head (e.g., four or higher degrees of freedom among the print head and build plate). As another example, the print head may be mounted on a robotic arm having three, four, five, six, or higher degrees of freedom; and/or the build platform may rotate, translate in three dimensions, or be spun.

FIG. 1B depicts an embodiment of the apparatus 1000 applying the filament 2 to build a structure. In one embodiment, the filament 2 is a metal filament for printing a metal object. In one embodiment, the filament 2 is a fiber reinforced composite filament (also referred to herein as continuous core reinforced filament) may be a push-pulpreg that is substantially void free and includes a polymer or resin 4 that coats or impregnates an internal continuous single core or multistrand core 6. In one embodiment, the filament 2 is an unreinforced filament.

The filament 2 is fed through a nozzle 10a disposed at the end of the print head 10, and heated to extrude the filament material for printing. In the case that the filament 2 is a fiber reinforced composite filament, the filament 2 is heated to a controlled push-pultrusion temperature selected for the matrix material to maintain a predetermined viscosity, and/or a predetermined amount force of adhesion of bonded ranks, and/or a surface finish. The push-pultrusion may be greater than the melting temperature of the polymer 4, less than a decomposition temperature of the polymer 4 and less than either the melting or decomposition temperature of the core 6.

After being heated in the nozzle 10a and having its material substantially melted, the filament 2 is applied onto the build platen 16 to build successive layers 14 to form a three dimensional structure. One or both of (i) the position and orientation of the build platen 16 or (ii) the position and orientation of the nozzle 10a are controlled by a controller 20 to deposit the filament 2 in the desired location and direction. Position and orientation control mechanisms include gantry systems, robotic arms, and/or H frames, any of these equipped with position and/or displacement sensors to the controller 20 to monitor the relative position or velocity of nozzle 10a relative to the build platen 16 and/or the layers 14 of the object being constructed. The controller 20 may use sensed X, Y, and/or Z positions and/or displacement or velocity vectors to control subsequent movements of the nozzle 10a or platen 16. The apparatus 1000 may optionally include a laser scanner 15 to measure distance to the platen 16 or the layer 14, displacement transducers in any of three translation and/or three rotation axes, distance integrators, and/or accelerometers detecting a position or movement of the nozzle 10a to the build platen 16. The laser scanner 15 may scan the section ahead of the nozzle 10a in order to correct the Z height of the nozzle 10a, or the fill volume required, to match a desired deposition profile. This measurement may also be used to fill in voids detected in the object. The laser scanner 15 may also measure the object after the filament is applied to confirm the depth and position of the deposited bonded ranks. Distance from a lip of the deposition head to the previous layer or build platen, or the height of a bonded rank may be confirmed using an appropriate sensor.

Various 3D-printing aspects of the apparatus 1000 are described in detail in U.S. Patent Application Publication No. 2019/0009472, which is incorporated by reference herein in its entirety.

### Optimized Reinforcement Design Operation

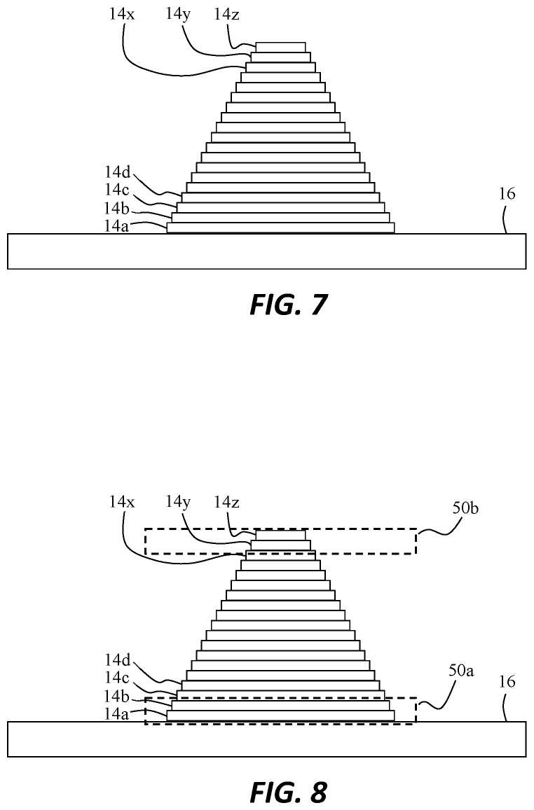

Various operations will be described herein with reference to an example illustrated in FIG. 7 of a 3D part for printing, the example being a pyramid (parallelogram) of decreasing width as height increases. As shown in FIG. 7, the part is printed by forming successive print layers. In this example, the initial four print layers are denoted by 14a through 14d, while the final three layers are denoted by 14x through 14z.

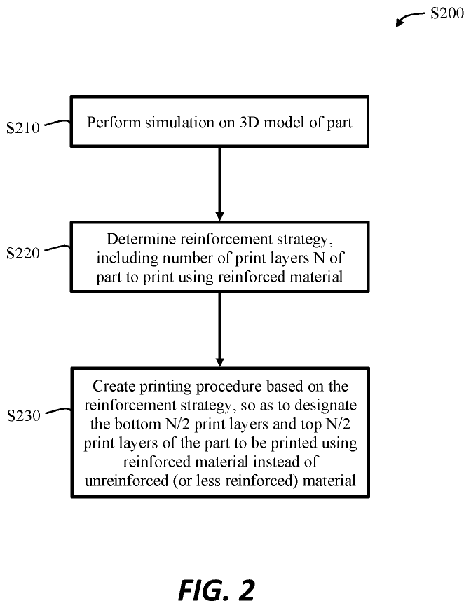

FIG. 2 illustrates an operation S200 for determining and applying a reinforcement strategy for a part to be printed which optimizes the use of reinforced print material.

In step S210, the controller 20 performs a simulation on a 3D model of the part to be printed. The simulation determines a resulting part strength, stiffness, and/or other mechanical requirements associated with the part. The simulation may include, but is not limited to, static stress analysis of applied loading, dynamic stress analysis of applied loading, fatigue analysis of applied cyclic loading, natural frequency analysis, buckling analysis of applied compressive loading, and thermo-mechanical residual stress analysis of the printing process.

In step S220, the controller 20 determines a reinforcement strategy, including a number of print layers N of the part to print using reinforced (e.g., with fiber) material rather than unreinforced (or less reinforced) material, such that target strength, stiffness, and/or other mechanical requirements are satisfied. In one embodiment, the controller 20 begins at a minimum threshold for the number of print layers N, performs a simulation based on that value of N, and continues to increment N and re-simulate until all defined requirements are satisfied. In one embodiment, the controller 20 performs simulations on various models having varying numbers of print layers N (e.g., ranging from no fiber layers to maximal fiber layers), applies the simulation results to generate one or more interpolating functions for variables corresponding to the defined requirements, and utilizes the interpolating function(s) to determine the optimal number of layers to meet the requirements. In the example of FIG. 7, the operation S200 determines that N=2.

In step S230, the controller 20 creates a printing procedure based on the reinforcement strategy, so as to designate the bottom N/2 print layers and top N/2 print layers of the part to be printed using reinforced material instead of unreinforced (or less reinforced) material. In one embodiment, the remaining layers are designated for printing using the unreinforced (or less reinforced) material. FIG. 8 illustrates the example of FIG. 7, with these layers designated to be printed using reinforced material. As shown in FIG. 8, the bottom N/2 print layers 50a (encompassing print layers 14a and 14b) and the top N/2 print layers 50b (encompassing print layers 14y and 14z) are designated to be printed using reinforced material

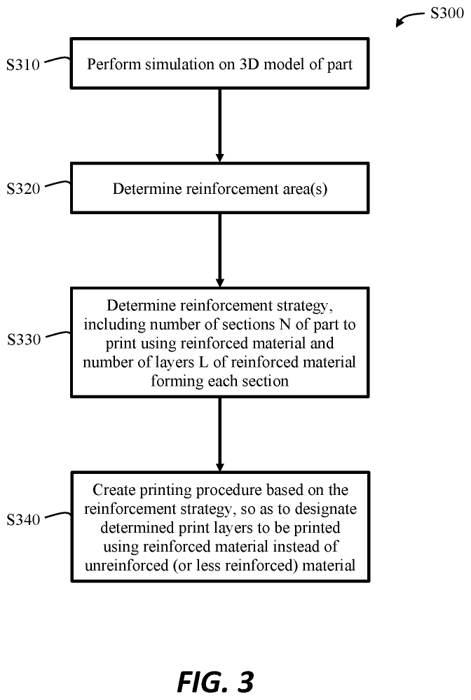

FIG. 3 illustrates an operation S300 for determining and applying a reinforcement strategy for a part to be printed which optimizes the use of reinforced print material. Operation S300 differs from operation S200 in that instead of designated the print layers at the top and bottom of the part to be printed with reinforced material, certain print layers in a reinforcement area of the part are designated to be printed with reinforced material. In effect, operation S300 configures the printing operation to print one or more “stripes” of reinforced material, each “stripe” being formed of one or more reinforced print layers (e.g., horizontal planes)

In step S310, the controller 20 perform a simulation on a 3D model of the part to be printed, similar to step S210. The simulation determines a resulting part strength, stiffness, and/or other mechanical requirements associated with the part.

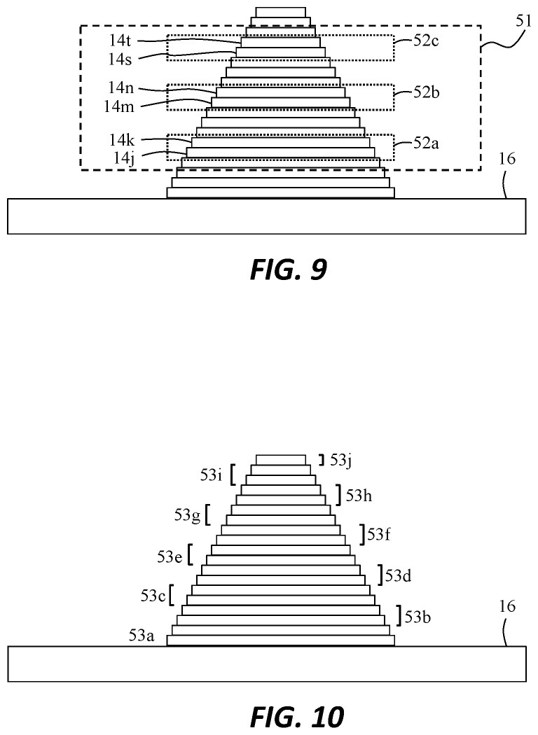

In step S320, the controller 20 determines one or more reinforcement areas for the part, based on the simulation. The reinforcement areas(s) may include, for example, areas surrounding the center of mass, bounding box, and/or areas with high stress/strength ratios (indicative of areas prone to failure). In one embodiment, the controller 20 may determine the reinforcement area(s) based on the mechanical performance of the unreinforced model (e.g., based on the results from the simulation performed in step S310). In one embodiment, the controller 20 may determine the reinforcement area(s) based on one or more definitions and/or inputs from a user. FIG. 9 illustrates the example of FIG. 7, with a determined reinforcement area 51.

In step S330, the controller 20 determines a reinforcement strategy including (i) a number of sections (or bands) N of the part to print using reinforced material rather than unreinforced material and (ii) a number of layers L of reinforced material forming each section/band, such that the target strength, stiffness, and/or other mechanical requirements are satisfied. The values for N and L may be determined in a number of various ways. In one embodiment, each section/band is effectively a “sandwich panel” formed of stacks of sheets (layers) of reinforced material (e.g., carbon fiber) having different fiber orientations. For example, a stack may be formed of four sheets (i.e., L=4) having fiber orientations of −45°, 0°, 45°, and 90°. The particular height of the stack and the orientations of each sheet may depend on the desired properties of the panel based on the mechanical requirements for the part. Therefore, the controller 20 may determine a value for L, such as by selecting a value that satisfies height requirements for the panel and/or the mechanical requirements. The controller 20 may then determine a value for N, similar to the approaches for determining N as described with respect to step S220.

In step S340, the controller 20 creates the printing procedure based on the reinforcement strategy, so as to designate the determined print layers from step S320 to be printed using reinforced material rather than unreinforced (or less reinforced) material. In one embodiment, the remaining layers are designated for printing using the unreinforced (or less reinforced) material. FIG. 9 illustrates, based on the example of FIG. 7, an example where N=3 (e.g., three sections 52a, 52b, 52c to print using reinforced material) and L=2 (e.g., each section is composed of two print layers).

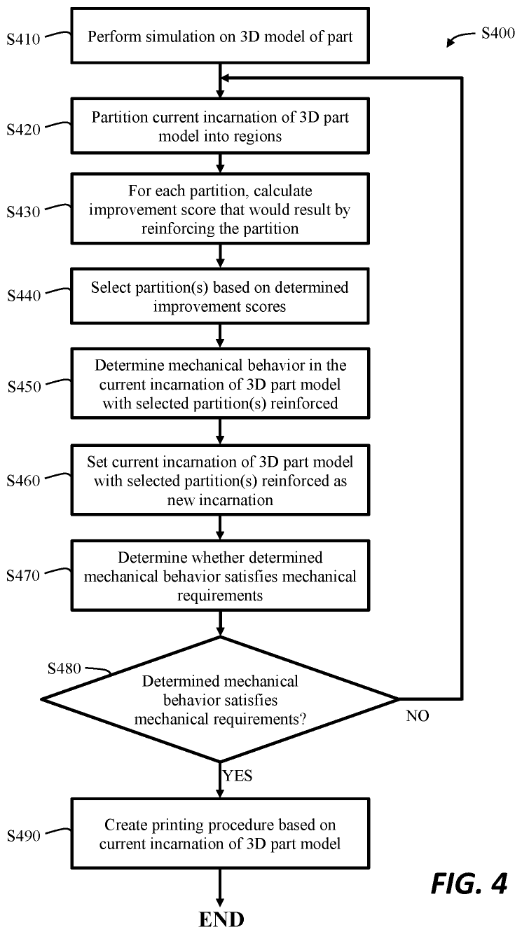

FIG. 4 illustrates an operation S400 for determining a reinforcement strategy for a part being printed which optimizes the use of reinforced print material. Operation S400 differs from operation S200 in its application of an iterative approach of applying successive rounds of reinforcement modifications, and performing local reinforcement optimization using differential analysis at each round. For instance, it is recognized that applying successively more amounts of reinforcement to a certain portion of a part (e.g., the portion deemed the weakest) may have diminishing returns after a certain point. As such, a reinforcement strategy that keeps adding reinforcement to the same area may not provide an optimal amount of strength improvement compared to a strategy that applies a smaller amount of reinforcement to that area but also applies an amount of reinforcement to another area. Indeed, the weakest portion on a part may change once a round of reinforcement application is applied.

In step S410, the controller 20 performs a simulation on a 3D model of the part to be printed, similar to step S210. The simulation determines a resulting part strength, stiffness, and/or other mechanical requirements associated with the part.

In step S420, the controller 20 partitions the current incarnation of the 3D part model into multiple regions. Such partitioning may be performed according one or more methodologies. For example, the partitioning may be based on an individual print-layer-by-print-layer basis or on groupings of multiple successive print layers, may be localized within an individual print layer. The partitioning may be any combination of one or more of X, Y, and Z directions. The partitioning may exclude certain print layers in circumstances where providing reinforcement (e.g., fiber) on such print layers may not a viable and/or desirable option. In one embodiment, the regions are non-overlapping. In one embodiment, at least two of the regions partially overlap. In one embodiment, the same partitioning is used throughout the operation S400, so if step S420 had already been performed, the previous partitioning is re-used.

A partition may be composed of a layer, a 2D shape that extends in the third dimension (e.g., an X-Y shape that extends in the Z direction, an X-Z shape that extends in the Y direction, a Y-Z shape that extends in the X direction, a shape that extends in a radial direction, etc.), a full 3D-defined shape, and/or any other defined shape. In one embodiment where partitioning is performed based on print layers, a lower threshold for the number of layers (e.g., 5 layers) and/or an upper threshold for the number of layers (e.g., 50 layers, or even up to the number of layers of the entire part) per partition may be applied. In one embodiment, the controller 20 receives information from a user that defines, restricts, and/or influences the criteria used for partitioning such as, but not limited to, a particular partitioning direction (e.g., X, Y, and/or Z), the number of print layers per partition (or a lower and/or upper limit thereof), a setting on the aggressiveness for separating the part into partitions, etc.

In the example of FIG. 7, one non-limiting example of partitioning is to, as illustrated in FIG. 10, define a partition on a layer basis for every 2 layers, as partitions 53a, 53b, . . . , 53j.

In step S430, the controller 20 determines, for each partition, an improvement score corresponding to a level of improvement if that partition is reinforced on the current incarnation of the 3D part model. The improvement score may be calculated based on, for example, a heuristic of the stress field (or of some other parameter). The improvement score may be based on the mechanical behavior in the current incarnation of the 3D part model with the reinforcement applied to that partition. Such mechanical behavior may include, for example, strength and/or stiffness. The improvement score may, for example, take into account the specific geometry, may depend on specific goals/objectives, and/or may be based on user input.

In one embodiment, the improvement score is a numerical figure. In one embodiment, the improvement score may be non-numerical (e.g., a hierarchy definition). In one embodiment, the improvement score is a ranking of improvement among some or all of the partitions.

In step S440, the controller 20 selects one or more partition(s) based on their respective improvement scores. Such selection may be a single partition or may be multiple partitions. Such selection may be based on region(s) with highest improvement score(s) when reinforced. Such selection may be based on region(s) having an improvement score satisfying a threshold.

In step S450, if multiple partitions are selected in step S440, the controller 20 determines an improvement score on the current incarnation of 3D part model with reinforcement applied to all partitions selected in step S440. If only a single partition is selected in step S440, this step may be skipped, as the improvement score determined from step S430 for the selected partition may be re-used.

In step S460, the controller 20 sets the current incarnation of the 3D part model with reinforcement applied to the selected partition(s) from step S450, as the new current incarnation of the 3D part model.

In step S470, the controller 20 determines whether the current incarnation of the 3D part model (i.e., with reinforcement applied to the selected partition(s)) satisfies mechanical requirements. These mechanical requirements may include one or more of a safety factor or goal, a minimum strength and/or stiffness (and/or other mechanical characteristic), percentage or magnitude in improvement of strength and/or stiffness (and/or other mechanical characteristic), percentage or magnitude in diminishing returns (e.g., marginal improvement in strength, stiffness, and/or other mechanical characteristic relative to required reinforcement material usage for further reinforcement, cost/improvement ratio, etc.), and/or any other desired mechanical requirement. In one embodiment, the controller 20 receives information from a user that defines, restricts, and/or influences the mechanical requirement attribute(s).

In step S480, if the controller 20 determines that the current incarnation of the 3D part model, with reinforcement applied to selected partition(s), satisfies the mechanical requirements, the operation proceeds to step S490. Otherwise, the operation returns to step S420.

In step S490, the controller 20 creates a printing procedure based on the current incarnation of 3D part model, so as to designate the identified portions in the 3D part model to be printed using reinforced material rather than unreinforced (or less reinforced) material.

In one embodiment, the partitions determined in step S420 do not overlap, so each point within the 3D part model is covered by at most one partition. In one embodiment, the partitions are allowed to overlap. For instance, overlapping partitions where the overlap is focused on the determined weakest area of the 3D part model may provide the ability to explore different ways of addressing the weakness.

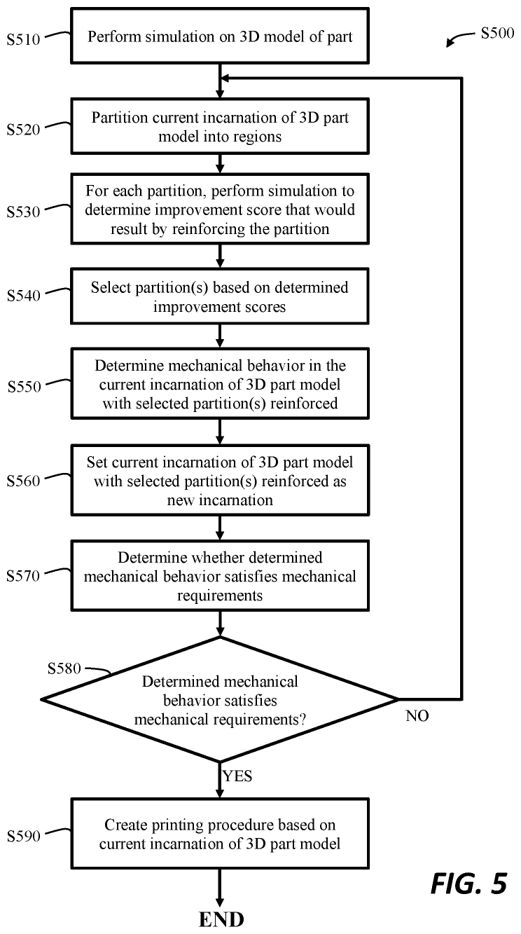

FIG. 5 illustrates an operation S500 for determining a reinforcement strategy for a part being printed which optimizes the use of reinforced print material. Operation S500 differs from operation S400 in that instead of using an improvement score calculated based on a heuristic of the stress field and/or some other parameter, an improvement score is determined by performing a simulation on each option of partitions.

In step S510, the controller 20 performs a simulation on a 3D model of the part to be printed, similar to step S210. The simulation determines a resulting part strength, stiffness, and/or other mechanical requirements associated with the part.

In step S520, the controller 20 partitions the current incarnation of the 3D part model into multiple regions, similar to step S420. As noted above, in the example of FIG. 7, one non-limiting example of partitioning is to, as illustrated in FIG. 10, define a partition on a layer basis for every 2 layers, as partitions 53a, 53b, . . . , 53j. In one embodiment, the controller 20 utilizes the results (e.g., resulting stress field) of the simulation from step S510 to determine parameters for the partitioning.

In step S530, the controller 20 performs, for each partition, a simulation on the current incarnation of the 3D part model with reinforcement applied to that partition and compare results against simulation results of current incarnation of 3D part model, to determine an improvement score. In one embodiment, The controller 20 may perform the simulation based on a heuristic of the stress field (or of some other parameter). The improvement score may be based on the mechanical behavior in the current incarnation of the 3D part model with the reinforcement applied to that partition. Such mechanical behavior may include, for example, strength and/or stiffness. The improvement score may, for example, take into account the specific geometry, may depend on specific goals/objectives, and/or may be based on user input.

In one embodiment, the improvement score is a numerical figure. In one embodiment, the improvement score may be non-numerical (e.g., a hierarchy definition). In one embodiment, the improvement score is a ranking of improvement among some or all of the partitions.

Again, step S530 differs from step S430 in that the controller 20 determines an improvement score by performing a simulation on each reinforcement option (e.g., each partition that may be reinforced) rather than by performing calculations based on a heuristic of the stress field and/or some other parameter.

In step S540, the controller 20 selects one or more partition(s) based on their respective improvement scores, similar to step S440. Such selection may be a single partition or may be multiple partitions. Such selection may be based on region(s) with highest improvement score(s) when reinforced. Such selection may be based on region(s) having an improvement score satisfying a threshold.

In step S550, if multiple partitions are selected in step S540, the controller 20 performs a simulation on the current incarnation of 3D part model with reinforcement applied to all partitions selected in step S540, to determine an improvement score. If only a single partition is selected in step S540, this step may be skipped, as the improvement score determined from step S530 for the selected partition may be re-used.

In step S560, the controller 20 sets the current incarnation of the 3D part model with reinforcement applied to the selected partition(s) from step S550, as the new current incarnation of the 3D part model, similar to step S460.

In step S570, the controller 20 determines whether the current incarnation of the 3D part model (i.e., with reinforcement applied to the selected partition(s)) satisfies mechanical requirements, similar to step S470. These mechanical requirements may include one or more of a safety factor or goal, a minimum strength and/or stiffness (and/or other mechanical characteristic), percentage or magnitude in improvement of strength and/or stiffness (and/or other mechanical characteristic), percentage or magnitude in diminishing returns (e.g., marginal improvement in strength, stiffness, and/or other mechanical characteristic relative to required reinforcement material usage for further reinforcement, cost/improvement ratio, etc.), and/or any other desired mechanical requirement. In one embodiment, the controller 20 receives information from a user that defines, restricts, and/or influences the mechanical requirement attribute(s).

In step S580, if the controller 20 determines that the current incarnation of the 3D part model, with reinforcement applied to selected partition(s), satisfies the mechanical requirements, the operation proceeds to step S590. Otherwise, the operation returns to step S520.

In step S590, the controller 20 creates a printing procedure based on the current incarnation of 3D part model, so as to designate the identified portions in the 3D part model to be printed using reinforced material rather than unreinforced (or less reinforced) material.

In summary, operation S500, for each iteration, partitions the 3D part into regions (non-overlapping or overlapping), simulates the 3D part based on an application of reinforcement for each respective region, and selects the region(s) having the highest amount of improvement from reinforcement.

It will be appreciated that operation S500 may involve more of a “brute force” approach compared to operation S400, in that operation S500 may involve additional computation. However, it will also be appreciated that operation S500 may produce better results than operation S400, especially if the heuristic of the stress field of the 3D part is not known or easily determinable.

In one embodiment, the partitions determined in step S520 do not overlap, so each point within the 3D part model is covered by at most one partition. In one embodiment, the partitions are allowed to overlap. For instance, overlapping partitions where the overlap is focused on the determined weakest area of the 3D part model may provide the ability to explore different ways of addressing the weakness.

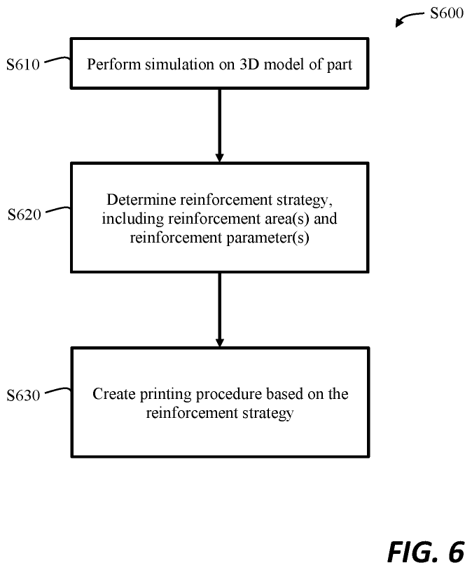

FIG. 6 illustrates an operation S600 for optimizing the use of reinforced print material on a part to be printed. Operation S600 is similar to operation S300 except that operation S600 also incorporates differential reinforcement, such as with particular modifier regions. Differential reinforcement provides improved granularity in the application of reinforcement, in that the reinforcement may not simply be a binary “on/off” but may further involve additional reinforcement parameters. For example, differential reinforcement may include a specific amount (e.g., percentage) of reinforcement. Differential reinforcement may include scaling within each region. Differential reinforcement may classify regions for reinforcement according to some description, such that operation S600 applies the appropriate reinforcement applied based on the classification. Different reinforcement may also distinguish between isometric and concentric reinforcement. Differential reinforcement may include the addition of support structures, such as a hole in the part to accept a bolt. Differential reinforcement may include the alignment of print material (e.g., plastic and/or fiber) to a particular geometry-dependent orientation. Differential reinforcement may include an increase the density of print material (e.g., plastic and/or fiber), such as modifying the spacing between extruded print material. Differential reinforcement may include adding fiber reinforcement in regions where there is otherwise none. Differential reinforcement may include removing existing fiber reinforcement where its addition/existence may be counterproductive (such as in an embodiment described below where operation S600 starts with a fully-reinforced model of the 3D part and works backwards to selectively remove reinforcement. Differential reinforcement may include an adjustment of a wall to infill ratio. Differential reinforcement may include changing of an infill pattern. Differential reinforcement may include decreasing and/or increasing the number of roofs and floors for the part. Differential reinforcement may include adjusting the part geometry itself, such as to increase the thickness of the part. Differential reinforcement may include adding fiber of different types (e.g., carbon fiber v. fiberglass v. Kevlar, etc.). It will be recognized that differential reinforcement may include additional parameters beyond those specific examples described above.

In step S610, the controller 20 performs a simulation on a 3D model of the part to be printed, similar to step S210. The simulation determines a resulting part strength, stiffness, and/or other mechanical requirements associated with the part.

In step S620, the controller 20 determines a reinforcement strategy including reinforcement area(s) and reinforcement parameter(s) for the part. The reinforcement strategy may include one or more of locations for reinforcement, an amount (e.g., percentage) of reinforcement for different areas, a classification of regions for reinforcement, a density of reinforcement (e.g., fiber density), an alignment of reinforcement (e.g., geometry dependent orientation), a removal of existing reinforcement, an adjustment of wall to infill ratio, a modification of an infill pattern, a modification of the number of roofs and floors of the part, and/or any other aspects relating to reinforcement/strength of the part.

As one example, based on the simulation of the 3D model of the part in step S610, the controller 20 in step S620 may determine that the unreinforced model is too compliant (e.g., flexible) in layers 50 through 65 and in layers 100 through 105, and may also determine a quantifiable measure(s) of such excess compliance. In one embodiment, the controller 20 may access information regarding the effect of potential reinforcement strategies on excess compliance. For instance, where available potential reinforcement methods include (i) solid fill and (ii) isotropic carbon fiber, the controller 20 may have information (e.g., pre-stored or otherwise accessible) as to how each of these reinforcement methods addresses excess compliance. Based on such accessible information, the controller 20 may determine, for example, that a reinforcement strategy using a solid fill in layers 50 through 65 and isotropic carbon fiber in layers 100 through 105 will satisfy the requirements. In one embodiment, the controller 20 may perform a simulation for each of the potential reinforcement methods, to determine which method(s) to incorporate into the reinforcement strategy.

In step S630, the controller 20 creates a printing procedure based on the reinforcement strategy, so as to designate the identified portions (e.g., print layers and/or print areas) in the 3D part model to be printed according to the reinforcement strategy. That is, the created printing procedure will incorporate the reinforcement strategy including the application of reinforced material according to the reinforcement strategy.

In one embodiment, operation S600 starts with an unreinforced 3D part model and step S620 determines a reinforcement strategy by selectively adding reinforcement. In one embodiment, operation S600 starts with a fully-reinforced 3D part model and step S620 determines a reinforcement strategy by selectively removing reinforcement (e.g., in areas where its addition/existence is not useful or even counterproductive).

Other aspects encompassed by the present invention may include, but are not limited to:
(1) Use of physical experiments—The present invention may determine the fitness and/or accuracy of any given 3D part model and strength and/or other mechanical requirements by alternatively or additionally receiving input based on physical experiments, and/or comparing input based on physical experiments with simulation results.
(2) Analysis of specific “load paths”—The present invention may analyze specific load paths based on a simulation, and determine a reinforcement strategy along those paths. For instance, such determination may be employed in combination with partitioning. As one example, for a part composed of a plate with a hole, the load path may trace around that hole.
(3) Geometry search—The present invention may search a database for other 3D parts that are similar to the current 3D part. present invention may use reinforcement settings from those other 3D parts as guidance in determining the reinforcement strategy for current 3D part.
(4) Feature detection—The present invention may detect one or more features in the 3D part model and determine a reinforcement strategy based on the identified feature(s).
(5) Heuristic Optimization—The present invention may utilize heuristic optimization. This feature may be used to determine a final state much more quickly, may be used to extrapolate load cases from similar parts, and/or may be used to determine initial conditions for optimization.
(6) Other simulation techniques—The present invention may utilize other simulation techniques besides feature detection. For example, the present invention may incorporate other approaches to solid mechanics and/or other types of physics that may warrant different numerical techniques.
(7) Accounting for discontinuities—The present invention may determine a reinforcement strategy that accounts for any discontinuity in mechanical performance resulting from substitution of reinforced (e.g., fiber) material. For example, the present invention may determine a reinforcement strategy that accounts for limitations in 3D printing involving both unreinforced and reinforced materials, for improved print success. In determining a reinforcement strategy, the present invention may recognize certain portions of the 3D part may not be printable successfully using reinforced material.

### Other Embodiments

Incorporation by reference is hereby made to U.S. Pat. Nos. 10,076,876, 9,149,988, 9,579,851, 9,694,544, 9,370,896, 9,539,762, 9,186,846, 10,000,011, 10,464,131, 9,186,848, 9,688,028, 9,815,268, 10,800,108, 10,814,558, 10,828,698, 10,953,609, U.S. Patent Application Publication No. 2016/0107379, U.S. Patent Application Publication No. 2019/0009472, U.S. Patent Application Publication No. 2020/0114422, U.S. Patent Application Publication No. 2020/0361155, U.S. Patent Application Publication No. 2020/0371509, and U.S. Provisional Patent Application No. 63/138,987 in their entireties.

Although this invention has been described with respect to certain specific exemplary embodiments, many additional modifications and variations will be apparent to those skilled in the art in light of this disclosure. For instance, while reference has been made to an X-Y Cartesian coordinate system, it will be appreciated that the aspects of the invention may be applicable to other coordinate system types (e.g., radial). It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. An apparatus comprising:
at least one processor; and
at least one memory,
wherein the at least one memory stores computer-readable instructions which, when executed by the at least one processor, cause the processor to:
receive design data corresponding to an object;
determine, based on the design data, at least one physical property of the object in the case that the object is 3D-printed using a first print material;
determine, based on the design data, one or more portions of the object to be printed using a second print material different from the first print material, the second print material having an increased reinforcement amount compared to the first print material; and
generate production data based on the design data and the one or more portions determined to be printed using the second print material.

2. The apparatus of claim 1, wherein the at least one physical property includes a strength of the object.

3. The apparatus of claim 2, wherein the determining of the strength of the object includes performing a simulation based on the design data.

4. The apparatus of claim 1, wherein the reinforced material is a fiber reinforced material.

5. The apparatus of claim 1, wherein the determining the one or more portions of the object to be printed using a second print material includes:
partitioning the object into one or more portions, based on a criteria;
determining a first change in at least one of the at least one physical property in the case that a respective portion of the object is printed using the second print material instead of the first print material; and
selecting at least one of the one or more first portions of the object, based on the respective determined first change.

6. The apparatus of claim 5, wherein the partitioning is performed according to one or more print layers.

7. The apparatus of claim 5, wherein the partitioning is performed in areas within a print layer.

8. The apparatus of claim 5, wherein the determining the one or more portions of the object to be printed using a second print material further includes:
determining, in a case that the at least one physical property does not satisfy a threshold after the first change, a second change in at least one of the at least one physical property in the case that a respective portion of the object is printed using the second print material instead of the first print material; and
selecting at least one of the one or more second portions of the object, based on the respective determined second change.

9. The apparatus of claim 1, wherein the determining the one or more portions of the object to be printed using a second print material includes:
determining a number of sections of the object to print using the second print material, and
determining a number of print layers per determined section.

10. A method comprising:
receiving design data corresponding to an object;
determining, based on the design data, at least one physical property of the object in the case that the object is 3D-printed using a first print material;
determining, based on the design data, one or more portions of the object to be printed using a second print material different from the first print material, the second print material having an increased reinforcement amount compared to the first print material; and
generating production data based on the design data and the one or more portions determined to be printed using the second print material.

11. The method of claim 10, wherein the at least one physical property includes a strength of the object.

12. The method of claim 11, wherein the determining of the strength of the object includes performing a simulation based on the design data.

13. The method of claim 10, wherein the reinforced material is a fiber reinforced material.

14. The method of claim 10, wherein the determining the one or more portions of the object to be printed using a second print material includes:
partitioning the object into one or more portions, based on a criteria;
determining a first change in at least one of the at least one physical property in the case that a respective portion of the object is printed using the second print material instead of the first print material; and
selecting at least one of the one or more first portions of the object, based on the respective determined first change.

15. The method of claim 14, wherein the partitioning is performed according to one or more print layers.

16. The method of claim 14, wherein the partitioning is performed in areas within a print layer.

17. The method of claim 14, wherein the determining the one or more portions of the object to be printed using a second print material further includes:
determining, in a case that the at least one physical property does not satisfy a threshold after the first change, a second change in at least one of the at least one physical property in the case that a respective portion of the object is printed using the second print material instead of the first print material; and
selecting at least one of the one or more second portions of the object, based on the respective determined second change.

18. The method of claim 10, wherein the determining the one or more portions of the object to be printed using a second print material includes:
determining a number of sections of the object to print using the second print material, and
determining a number of print layers per determined section.

19. A non-transitory computer-readable medium storing a computer program which, when executed by at least one processor, causes the processor to:
receive design data corresponding to an object;
determine, based on the design data, at least one physical property of the object in the case that the object is 3D-printed using a first print material;
determine, based on the design data, one or more portions of the object to be printed using a second print material different from the first print material, the second print material having an increased reinforcement amount compared to the first print material; and
generate production data based on the design data and the one or more portions determined to be printed using the second print material.

20. The non-transitory computer-readable medium of claim 19, wherein the at least one physical property includes a strength of the object.
